(19) United States
(12) Patent Application Publication
(10) Pub. No.: US 2004/0158878 A1
(43) Pub. Date: Aug. 12, 2004

(54) Power scalable digital video decoding

(76) Inventors: Viresh Ratnakar, Sunnyvale, CA (US); William Chen, Foster City, CA (US); Changick Kim, Cupertino, CA (US); Vasudev Bhaskaran, Sunnyvale, CA (US); Onur G. Guleryuz, Sunnyvale, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/360,977

(22) Filed: Feb. 7, 2003

(51) Int. Cl. H04N 7/16

(52) U.S. Cl. 725/150

(57) ABSTRACT

A method for decoding digital video data in a power scalable manner is provided. The method initiates with monitoring a power level available for the video decoding system. Then, threshold power levels are identified. In response to the power level available crossing one of the threshold power levels, the method includes changing both a power consumption level associated with the video decoding system and a video presentation quality. A method for determining optimum pairings of power consumption and video quality for a video decoding system is also provided. In addition, a power scalable video device, an integrated circuit chip for a video decoding system and a graphical user interface are provided.

### BACKGROUND OF THE INVENTION

1. Field of the Invention

This invention relates generally to digital image technology and more particularly to a method and apparatus for decoding digital video data in a power scalable manner.

2. Description of the Related Art

Portable electronic devices rely on batteries to provide the necessary power for the operation of the device. Consumers using the portable devices want to be able to use the devices for longer time periods in between having to recharge the batteries. As such, there is a continual effort to increase battery performance and to perform the operations in more energy efficient ways, even as the applications performed by the devices become more sophisticated, and in some cases, require more power. For example, cell phones, personal digital assistants (PDAs), etc. are moving to color display screens capable of displaying complex graphics at a high resolution. These devices require a considerable amount of power, relative to the battery life, to present the display images. In addition, as the sophistication of the graphics increases, the power requirements tend to increase.

One attempt to address the power concerns has been to identify sleep modes capable of limiting the power when the device is not being used. While sleep modes may cut back on power during non-usage periods, they do not address power consumption concerns while the device is being used. Video decoding for the display image presentation is a relatively large consumer of power. Consequently, sleep modes do not address the consumption of power during video decoding. Furthermore, simply not driving the display would save considerable power but is not a viable alternative here.

As a result, there is a need to solve the problems of the prior art to provide a method and apparatus for decoding video data in a power scalable manner thereby extending battery life for a portable electronic device.

### SUMMARY OF THE INVENTION

Broadly speaking, the present invention fills these needs by providing a device for decoding image data in a power scalable manner, according to the device's available power. It should be appreciated that the present invention can be implemented in numerous ways, including as a method, a system, computer readable media or a graphical user interface (GUI). Several inventive embodiments of the present invention are described below.

In one embodiment, a method for determining an optimum pairing of power consumption and video quality for a video decoder is provided. The method initiates with defining a target platform. Then, a plurality of video decoding profiles are identified. Next, the performance of each of the plurality of video decoding profiles is measured with a plurality of video streams. Then, a portion of the plurality of video decoding profiles is identified wherein each of the portion of the plurality of video decoding profiles is associated with a different power level.

In another embodiment, a method for decoding image data in a power scalable manner is provided. The method initiates with monitoring a power level available for the video decoding system. Then, threshold power levels are identified. In response to the power level available crossing one of the threshold power levels, the method includes changing both a power consumption level associated with the video decoding system and a video presentation quality.

In yet another embodiment, a computer program product having program instructions for decoding image data in a power scalable manner is provided. The computer program product includes program instructions for identifying threshold power levels and program instructions for monitoring a power level available for a video decoding system. Program instructions for determining when the power level available for the decoding system crosses one of the threshold power levels are included. Program instructions for changing both a power consumption level associated with the video decoding system and a video presentation quality, wherein the program instructions for changing are triggered by the power level available crossing one of the threshold power levels.

In still yet another embodiment, a power scalable video decoding device is provided. The power scalable video decoding device includes a processor configured to monitor an available power level for the video decoding system in order to select a decoding state for decoding image data, wherein the processor is enabled to adjust the decoding state based upon changes detected to the available power level. A memory configured to store compressed data and decoded frames associated with the compressed image data is included. A display screen configured to present the decoded frames and a bus enabling communication between the processor, the memory and the display screen are also included.

In another embodiment, an integrated circuit chip associated with a video decoding system is provided. The integrated circuit chip includes circuitry for monitoring a power level available to the video decoding system. Circuitry for selecting a video decoding state associated with a first quality level is included. The video decoding state is based upon the power level available to the video decoding system. Circuitry for determining when the power level available changes and crosses a threshold power level is provided. Crossing the threshold power level causes the circuitry for selecting the video decoding state to select a modified video decoding state associated with a second quality level. Circuitry for decoding image data according to a selected video decoding state is also included.

In yet another embodiment, a graphical user interface (GUI) rendered by a computing device is provided. The GUI includes a user interface for selecting a power consumption mode associated with a video decoder. The user interface includes computer code for triggering the selection of the power mode, wherein the user interface allows a user to choose between a plurality of video decoding states.

In still yet another embodiment, a method for storing image data for video decoding is provided. The method initiates with receiving compressed image data. Then, the compressed image data is decoded into decompressed image data. Next, luminance and chrominance data corresponding to a frame of image data is identified. Then, the luminance and chrominance data is stored for the frame of image data contiguously.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram of a device configured to provide power scalable digital video decoding in accordance with one embodiment of the invention.

FIG. 2 is a simplified schematic diagram representing the multiple modules contained within the video decoder in accordance with one embodiment of the invention.

FIG. 3 is a simplified schematic diagram representing the alternatives available for each of the module illustrated in FIG. 2 of the video decoder.

FIG. 4A is a simplified schematic diagram illustrating the concept of frame memory compression in accordance with one embodiment of the invention.

FIG. 4B is simplified block diagram illustrating an alternative representation for the frame memory compression module and associated alternatives in accordance with one embodiment of the invention.

FIG. 5A is a simplified schematic diagram representing a module associated with color conversion in accordance with one embodiment of the invention.

FIG. 5B is a simplified schematic diagram representing the color conversion reduced alternative in accordance with one embodiment of the invention.

FIG. 6 is a simplified schematic representing the extended error detection feature in accordance with one embodiment of the invention.

FIG. 7 is a graph of various states defined by different combinations of alternatives from the video decoding modules in accordance with one embodiment of the invention.

FIG. 8 is an alternative graphical representation of the power versus video quality plot of FIG. 7.

FIG. 9 is a simplified schematic diagram of the components of a video decoding system in accordance with one embodiment of the invention.

FIG. 10 represents a schematic diagram of a graphical interface enabling a user to manually select a power consumption level for video decoding in accordance with one embodiment of the invention.

FIG. 11 is a flow chart diagram representing the method operations for determining an optimum pairing of power consumption and video quality for a video decoder in accordance with one embodiment of the invention.

FIG. 12 is a flow chart diagram illustrating the method operations for decoding image data in a power scalable manner in accordance with one embodiment of the invention.

### DETAILED DESCRIPTION OF THE PREFERRED EMBODIMENTS

An invention is described for a system, device and method for decoding digital video data according to a decoding state associated with an available power level. It will be apparent, however, to one skilled in the art, in view of this disclosure, that the present invention may be practiced without some or all of these specific details. In other instances, well known process operations have not been described in detail in order not to unnecessarily obscure the present invention. The term “about” as used to herein refers to +/−10% of the referenced value.

The embodiments of the present invention provide a device, a system and method for decoding digital video data in a power scalable manner. As used herein, the terms “video data” and “image data” may be used interchangeably. The power scalability enables selecting an optimum video decoding state based upon the available power level. Thus, the video decoding state is adapted to the available power. In one embodiment, as the available power decreases, the system continues to decode and display video through video decoding states requiring less power. Of course, the video decoding states requiring less power provide a lower quality image. However, by adapting the decoding state to the power availability, the battery life for a handheld device, e.g., cellular phone, personal digital assistant (PDA), pocket personal computer, web tablet, etc., is extended so that video data may still be presented at low power levels. In one embodiment, the format of the video data is a block based standard, such as the Motion Picture Expert Group (MPEG) 4 standard. However, it should be appreciated that the invention is not limited to the MPEG 4 standard, as the embodiments described herein may be used with any suitable video and audio compression standard.

Power consumption for a video decoding device, discounting the power consumed in driving the display, may be characterized by the following equation:

P≈P_{I}I+PₘM

Here, P represents the power consumption, P_{I} represents the power consumption associated with the instruction count (I), and Pₘ represents the power consumption associated with the memory access count (M). As is generally known, Pₘ is typically substantially greater than P_{I}, therefore, reduction of the number of memory accesses significantly reduces power consumption. It should be appreciated that reduced computation, which reduces the instruction count, also conserves power. However, the level of power conserved is not of the same magnitude when compared to the power conserved through the reduction in the number of memory accesses.

The power scalable video decoding system described herein includes a plurality of decoding options, also referred to as modules, where each decoding option is associated with a plurality of different power consumption level alternatives. Each of the decoding states are defined by combinations of the alternatives from the modules. The decoding states correspond to platform specific profiles of instruction counts and memory accesses, which determine a quality level for each decoding state. Accordingly, by determining an available power level, a predefined decoding state associated with the available power level may be selected to present the image data in a power scalable manner. Of course, the power level may be expressed in terms of the amount of remaining power, the amount of power used or some other suitable marker.

FIG. 1 is a simplified schematic diagram of a device configured to provide power scalable digital video decoding in accordance with one embodiment of the invention. Device 100 includes decoder 102 and display screen 104. It should be appreciated that device 100 can be any portable electronic device, e.g., a personal digital assistant, a cellular phone, a web tablet, a pocket personal computer, a laptop computer, etc. Decoder 102 is configured to decode a video stream according to an available power level for device 100. That is, device 100 is battery operated, therefore, the power consumption of decoder 102 is adaptive in order to extend the battery life. In one embodiment, power scalable video decoder 102 includes a multiplicity of algorithms that are combined to define video decoding states in accordance with an available power level. As will be explained in more detail below, the video decoding states associated with device 100 provide a plurality of decoding profiles each having different instruction counts and memory accesses in order to accommodate varying available power levels.

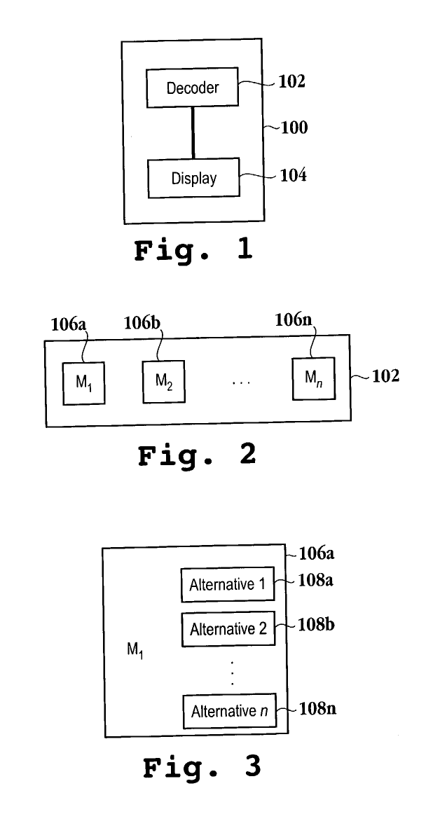

FIG. 2 is a simplified schematic diagram representing the multiple modules contained within the video decoder in accordance with one embodiment of the invention. Here, decoder 102 includes modules M₁ 106a, M₂ 106b, through Mₙ 106n. Each of modules M₁ through Mₙ are associated with a power level consumption. That is, as the power level decreases, modules requiring less power are selected for video decoding. In essence, built into decoder 102 are strategies for selecting the appropriate modules depending on the power level available to the video decoding system.

FIG. 3 is a simplified schematic diagram representing the alternatives available for each of the module illustrated in FIG. 2 of the video decoder. Module M₁ 106a includes alternatives 1 108a alternative 2 108b through alternative N 108n. Alternative 1 108a through alternative N 108n represent various schemes for providing the decoding offered through module M₁ 106a according to various power levels available. For example, alternative 1 108a may represent a full power alternative for completing the decoding of module M₁ 106a, while alternative N 108n may represent a low power alternative for completing the decoding. In addition, the quality level associated with alternative 1 will generally be higher than the quality level associated with alternative N 108n, as higher quality display presentations typically demand more power. In other words, the instruction count and the memory access count associated with alternative 1 108a will be higher than the instruction count and the memory access count associated with alternative N 108n. In turn, the power consumption associated with alternative 1 is higher than the power consumption associated with alternative N. In one embodiment, a system design phase selects which alternatives to make available for each module as will be explained in more detail below. It should be appreciated that as the number of modules increase and the number of alternatives increase, the corresponding number of decoding states available for the video decoding system also increases. Therefore, the system design phase identifies the optimum combinations for the various decoding states that are implemented for the video decoding system.

Described below are various modules along with alternatives associated with each of the modules that may be included in the video decoder in accordance with one embodiment of the invention. It should be appreciated that the modules in the various alternatives are illustrative and not meant to be limiting. That is, other suitable video decoding modules may be included as well as varying alternative levels.

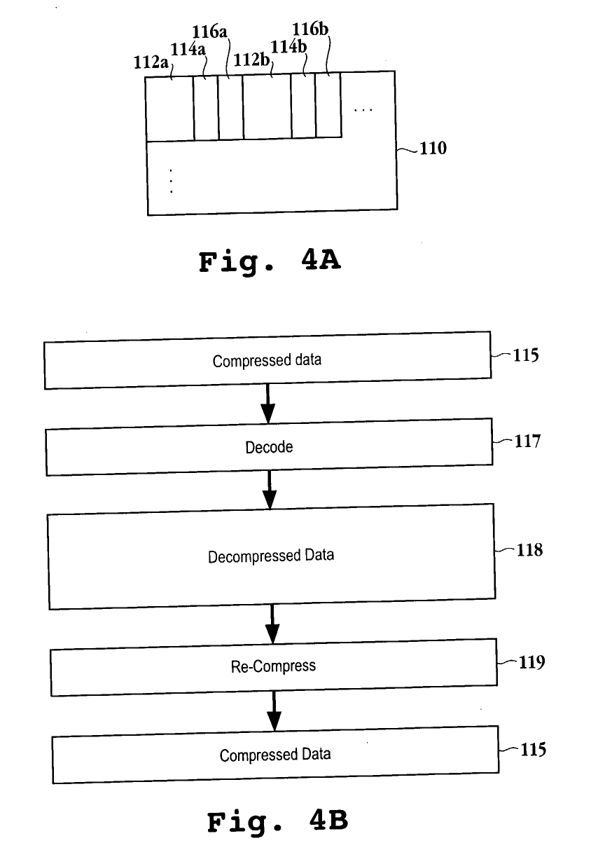

FIG. 4A is a simplified schematic diagram illustrating the concept of frame memory compression in accordance with one embodiment of the invention. During video decoding, motion compensation generally accounts for a relatively large portion of power consumption. Motion compensation requires that macro-blocks updated from past (and possibly future) reference frames be fetched from memory for creation of the frame being currently decoded. As is generally known, each frame of image data consists of luminance (Y) data, and sub-sampled chrominance (Cb, Cr) data. Decoded frames are uncompressed and stored in memory of the decoder for use in subsequent frames, since subsequent frames are decoded as differential plus motion information from previous frames. In one embodiment, one alternative associated with the frame memory compression module stores decoded frames in their entirety. An optimized form of storage of the decoded frames in the decoder is to store Y, Cb, Cr data for each macro-block contiguously. Block 112a represents Y data, block 114a represents Cb data and block 116a represents Cr data of a macro-block. This pattern is repeated in memory 110 of the decoder as illustrated by blocks 112b, 114b, and 116b. It should be appreciated that by storing the data for each macro-block contiguously, instead of storing all of the Y data for the frame followed by all of the Cb data for the frame and then all of the Cr data for the frame, will improve locality of memory access and hence reduce cache misses. That is, when the Y data of a macro-block is fetched from memory, the Cb and Cr data are also likely to get fetched and cached as caches typically operate on chunks of several bytes. It should be appreciated that the above described alternative for frame memory compression represents the highest power and the highest quality of presentation data.

FIG. 4B is simplified block diagram illustrating an alternative representation for the frame memory compression module and associated alternatives in accordance with one embodiment of the invention. Here, compressed data 115 is decoded in block 117 resulting in decompressed data 118. Decompressed data 118 is then recompressed in block 119 and stored again as compressed data 115. In one embodiment, the frame of data is re-compressed using a simple lossless compression technique such as differential pulse code modulation (DPCM) with variable length coding differences. This recompressed data is then stored. It should be appreciated that the recompressed data stores Y, Cb, and Cr values contiguously as illustrated with reference to FIG. 4A. In one embodiment, pointers to the beginning of each component of each block are also stored for fast access. Additionally, since the compression technique is lossless, the reconstructed image from the data has the same quality as that obtained without recompression. In this alternative, the instruction count, I, goes up, but the memory access count, M, goes down. That is, there is a slight computational overhead when grabbing areas across multiple macro-blocks, however, the improved performance of the cache more than offsets this overhead to provide for a lower level of power consumption. In one embodiment, the lossless compression achieves about 1:0.75 compression, therefore, whether this particular alternative reduces power as compared to the alternative for simply storing data contiguously as described above with reference to FIG. 4A, depends on the specific target platform. Another alternative for providing frame memory compression which requires even less power is an alternative where Y, Cb, Cr data for each macro-block is stored contiguously with moderate lossy compression. Here, the compression scheme is kept simple so as to avoid a large increase in the instruction count (I). In one embodiment, a DPCM compression technique followed by uniform quantization and fixed length encoding of differences is used. In another embodiment, the lossy version alternatives associated with frame memory compression provide for luminance differences being rounded to the nearest five-bit values, and chrominance differences being rounded to the nearest three-bit values. Accordingly, the lossy version runs at the same speed as the lossless version, and produces nearly indistinguishable results, while reducing memory usage to about ⅓ of the size. In yet another alternative for the frame memory compression module is a frame memory compression “lossy high” alternative. This alternative is essentially the same as the frame memory compression “lossy moderate” alternative described above but with a more aggressive quantizer and possibly a better compressing variable length code. It has been found that cache misses (M) scale down linearly with compressed frame size. In turn, the power consumption will drop as the cache misses drop. In one embodiment, the frame memory compression lossy alternatives provide up to about 100:40 compression ratios.

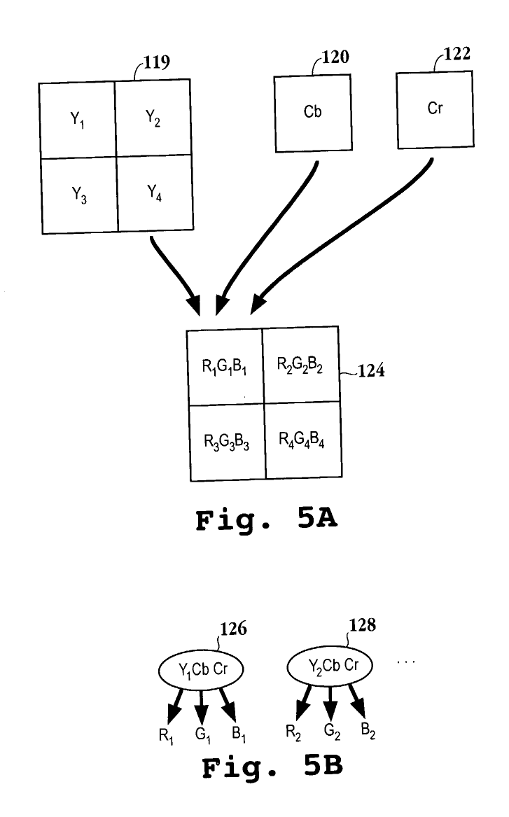

FIG. 5A is a simplified schematic diagram representing a module associated with color conversion in accordance with one embodiment of the invention. Decoded video data is typically in Y, Cb, Cr color format with the Cb and Cr components being sub-sampled. Color conversion involves generating red, green, and blue (RGB) data from this format. The Cb and Cr data needs to be sub-sampled, then linearly combined with Y for each pixel of a frame of image data. Accordingly, the color conversion module is a heavy consumer of instruction counts (I) as the conversion needs to be applied to each pixel. It should be appreciated that color conversion also involves memory accesses to fetch the Y, Cb, Cr data previously decoded, however, power scaling for those accesses is accounted for in the frame memory compression module discussed above. Hence, the alternatives discussed below with reference to color conversion focus on different instruction counts. In FIG. 5A, Cb block 120 and Cr block 122 are combined with Y₁ through Y₄ components of block 118 to generate the corresponding RGB values represented in block 124. One alternative, referred to as color conversion full uses standard equations for determining the color conversion. In one embodiment, the process may be optimized by using lookup tables for the contribution of each value of Y, Cb, Cr to each of the RGB values. In a second color conversion alternative vector quantization is used to create a lossy lookup table using a pair of consecutive Y values to pairs of contributions to RGB. Accordingly, computations are folded together at the expense of some quality in the second color conversion alternative in order to reduce instruction counts.

FIG. 5B is a simplified schematic diagram representing the color conversion reduced alternative in accordance with one embodiment of the invention. Here, a combined lookup table is used with vector quantization to map the Y, Cb, Cr values to R,G,B values. For example, to map a 24-bit Y, Cb, Cr triplet to R,G,B with a look-up table, the size of the table would be prohibitively large. In essence, in this alternative, the 24-bit value is quantized down to a smaller size (such as a 10-bit value), and then a look-up table of practical size is used to map the smaller size bit to R,G,B values.

A frame display skipping module may also be included in the decoder in accordance with one embodiment of the invention. As is generally known, decoding is required for each frame that may be used as a reference frame in motion compensation. Therefore, skipping the display of some frames would save power by way of avoiding color conversion and avoiding writing to the display memory. Thus, one alternative is to disable frame display skipping where all frames are displayed. For example, this alternative may be associated with the full power mode being available to the decoder. A second alternative is to enable frame display skipping. Here, a number of alternatives may be included where each alternative represents a different range such that one frame out of every K^{th} frame is not displayed. For example, K may equal ten, five, three, etc., for a frame rate of 15 frames-per-second video. It should be appreciated that any number of alternatives can be used where K can represent any suitable number of frames being displayed.

Frame scaling is yet another module that may be included in the video decoder. The frame scaling module reduces the amount of data stored for each frame in one embodiment. Here, a scaled-down version (1:2 in both directions) of each frame is stored. In one embodiment, the scaling down can be efficiently done directly on the DCT coefficients. During motion compensation, as well as for display, the video data may be scaled up using simple pixel replication. This reduces memory accesses and on balance, even in spite of the extra up/down scaling computations, reduces instruction counts as color conversion need only be done on the downsampled data. The alternatives associated with frame scaling include frame scaling off and frame scaling on alternatives. For the frame scaling off alternative no frame scaling is being performed. In one embodiment, the frame scaling off alternative is associated with full power being available to the video decoding system.

Another module available to the video decoding system is chroma skipping. The chroma skipping module allows for a display to be presented in full color or greyscale depending on the power level. Here, the alternatives for chroma skipping include chroma skipping off and chroma skipping on. For the alternative of chroma skipping on, the chroma data (Cb, Cr) is only parsed and then discarded. The resulting video is displayed in greyscale. Thus, a substantial reduction in both instruction counts and memory access counts is achieved as motion compensation only operates on Y and color conversion simply involves replicating Y as red, green and blue (RGB) data. It should be appreciated that the chroma data is parsed since the Y, Cb, Cr data is all interweaved. The alternative of chroma skipping off displays the video data in full color. Here, the display of the video data in full color corresponds to power levels that are relatively high, i.e., near full power levels.

Inverse discrete cosine transform (IDCT) represents another module of the video decoding system. In this embodiment, by trading off the accuracy of the inverse discrete cosine transform for resolution in computational complexity, an alternative that allows for the instruction count, I, to be substantially reduced is provided. The alternatives for this module include inverse discrete cosine transform full, inverse discreet cosine transform rough, and inverse discreet transform very rough. For the inverse discrete cosine transform full alternative, any suitable and fast but accurate integer is used for the inverse discrete cosine transform. For the IDCT rough alternative the accuracy of the IDCT is degraded to a moderate extent such as replacing some multiplication with approximate shifts, and ignoring some high frequency coefficients. For the IDCT very rough alternative, the accuracy of the IDCT is degraded to a greater extent using the same techniques as discussed above with respect to the IDCT rough alternative.

A deblocking and deringing module is also included in accordance with one embodiment of the invention. As is generally known for typical low bit rate video used by network handheld devices, post processing (deblocking and deringing) is important, however, the post processing consumes a high amount of power. The relatively high power consumption is related to both the instruction counts and the memory access counts being relatively high. The alternatives associated with the deblocking and deringing module include deblocking-deringing high, deblocking-deringing medium, deblocking-deringing low, and deblocking-deringing none. In one embodiment, a set of efficient and adaptive algorithms for combining pixel domain operations with fast compressed domain operations to achieve joint removal of blocking and ringing artifacts is employed. These algorithms use adaptive thresholds that determine whether or not filtering is to be applied to a pixel area, and if so, then which filter is to be used. By varying these adaptive thresholds, the different alternatives can be achieved. For example, deblocking and deringing high alternative will apply the most robust filtering operations to provide the highest quality display. The amount of post processing is accordingly scaled down for the deblocking-deringing medium alternative and even further scaled down for the deblocking-deringing low alternative. For the deblocking-deringing none alternative, all post processing is skipped, therefore, all the instruction count and memory access count cost is saved. Thus, the deblocking and deringing high alternative is associated with the near full power mode while the deblocking and deringing none alternative is associated with a low power mode with the remaining alternatives residing between these two extremes.

Error concealment is yet another module that may be included in the video decoder. Error concealment involves calling a series of procedures for INTER and INTRA macro-blocks (MB) that are deemed to be in error by error detection routines. Concealment algorithms for the INTER and INTRA blocks are listed below in TABLE 1.

TABLE 1

| | Motion | | Constant | Zero Motion |
|---|---|---|---|---|
| | prediction | DCT prediction | prediction | prediction |
| INTER MB | 1^{st} choice | 2^{nd} choice | | 3^{rd} choice |
| INTRA MB | | 1^{st} choice | 2^{nd} choice | |

Motion prediction for an INTER MB is performed by considering the available motion vectors in the surrounding macro-blocks. The median of the available motion vectors provides the motion prediction. Zero motion prediction is implemented by setting the predicted motion vectors to zero. Constant prediction for an INTRA macro-block is performed by considering a one pixel layer immediately surrounding the macro-block. For luminance, this corresponds to a maximum of 4×16 pixels, with 16 pixels each from the left, right, above and below macro-blocks. Depending on error conditions, only a portion of these blocks may be available in one embodiment. For chrominance, a maximum of 4×8 pixels is used for each channel and the available pixels are averaged to produce a prediction. Consequently, the macro-block is predicted to have the resulting constant color.

DCT prediction for an INTER or INTRA macro-block uses the DCT coefficients of surrounding INTRA macro-blocks. Here, the DCT-DC prediction is obtained as a simple average of surrounding macro-blocks DCT-DCs. One skilled in the art will appreciate that the DC coefficient is the upper leftmost coefficient of the DCT coefficient block. For DCT AC prediction, the first row of DCT-AC coefficients from the macro-blocks above and below is used to predict the first row of DCT-AC coefficients. Similarly, the first column of DCT-AC coefficients in macro-blocks to the left and right are used to predict the first column of DCT-AC coefficients. In one embodiment, the actual manner in which DCT-AC predictions are done may be altered through lookup tables. The first row of DCT-AC coefficients in the first luminance block are predicted from an average of the first row of DCT-AC coefficients in the above macro-block, using the third luminance block, and in the below macro-block using the first luminance block. The first column of DCT-AC coefficients in the first luminance block are predicted as an average from the first column of DCT-AC coefficients in the left macro-block, using the second luminance block, and in the right macro-block, using the first luminance macro-block. It should be appreciated that the above described scheme may be extended in a similar manner to other blocks in the macro-block for which DCT coefficients have to be predicted.

The error concealment module includes the alternatives of the error concealment on and error concealment off. For the error concealment on alternative full application of error concealment is provided. This includes motion vector prediction and discrete cosine transform coefficient prediction. Thus, due to the extra computation required for this alternative, it is most likely to be associated with a higher power availability mode. The error concealment off alternative identifies blocks of video to be an error and simply replaces those blocks by constant color holds. It should be appreciated that the computational overheads of error concealment are moderate and only for certain specific platform characteristics is there a power advantage in using the error concealment off alternative.

It should be appreciated that once an erroneous macro-block is predicted in some fashion, the error for the macro-block is suitably cleared so that this macro-block can be used in predicting other macro-blocks. In data partitioned modes any information for the motion vector or DCT-DC coefficients are incorporated into or used in place of the results of prediction. For example, for an INTER frame, if motion vectors are available they are used instead of Motion prediction. Similarly, for an INTER macro-block, if DCT-DC coefficients are available, then the DCT-DC coefficients of the “prediction error” are predicted with these coefficients whether the motion vector has been predicted or obtained via partitioned data. Of course, for an INTRA macro-block, available DCT-DC coefficients are used in place of the DCT predicted DC values on top of the predicted DCT-AC coefficients.

In one embodiment, when the erroneous macro-blocks in a frame exceeds about 80%, error concealment proceeds by copying the previous frame in place of the current frame. One exception to this convention is applicable for INTRA frames. Since an INTRA frame can be substantially different from a previous frame, a check is performed on the correctly received macro-blocks to see if the INTRA frame is similar (in mean absolute error) to the previous frame. If the INTRA frame is not similar, then copying of the previous frame is aborted and normal concealment operations are resumed.

Extended error detection is another module that may be included in the video decoder. When a block of video is found to be in error during parsing, it is often the case that the actual error began earlier in the bit stream but went unnoticed for a few blocks as the corrupted bit stream remained syntax compliant for a while. Extended error detection refers to a set of heuristics that have been devised to detect a situation where the error is noticed later and to correct that situation. The error, or errors, are detected by identifying blocks prior to the first detected error where the data seems unnatural. For example, the data may have lots of high frequency coefficients, the data may be an isolated intra-block on a P-frame, etc. In one embodiment, to detect macro-blocks that have been marked as acceptable but are probably in error, a window of macro-blocks before each erroneous macro-block is looked at. In one embodiment, for any video object plane (VOP) or frame in error, a window three times the width of the frame in macro-blocks is looked at. Within this window, any macro-block that satisfies one of the following three conditions may be marked as being in error. The three conditions include: 1) the macro-block has a block containing more than 16 discrete cosine transform coefficients; 2) the macro-block is an isolated intra macro-block and inter frame; 3) the macro-block is an intra frame and the DC difference of this macro-block with its neighbors (in Y or Cb or Cr) is greater than a threshold value.

The alternatives for the extended error detection module include the extended error detection being turned on or the extended error detection being turned off. It should be appreciated that when the extended error detection is turned on, there is a slight overhead in both instruction counts and memory access counts. Therefore, the extended error detection on alternative is used with higher power modes than the extended error detection off alternative.

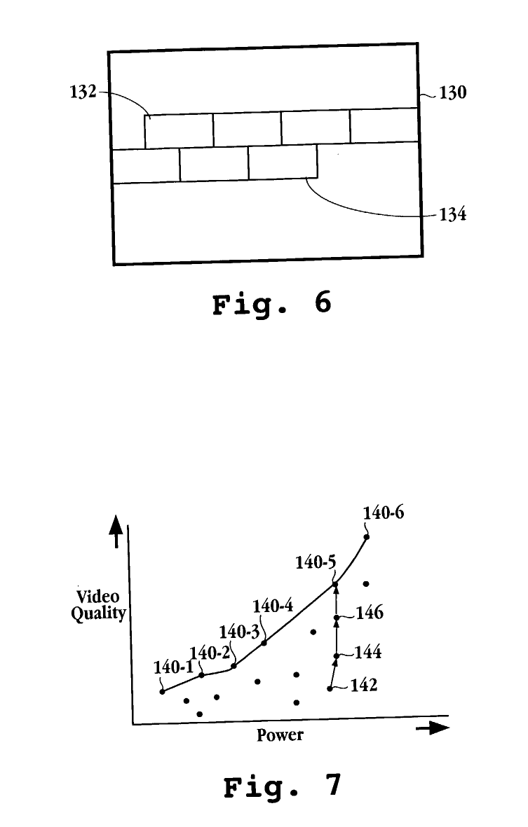

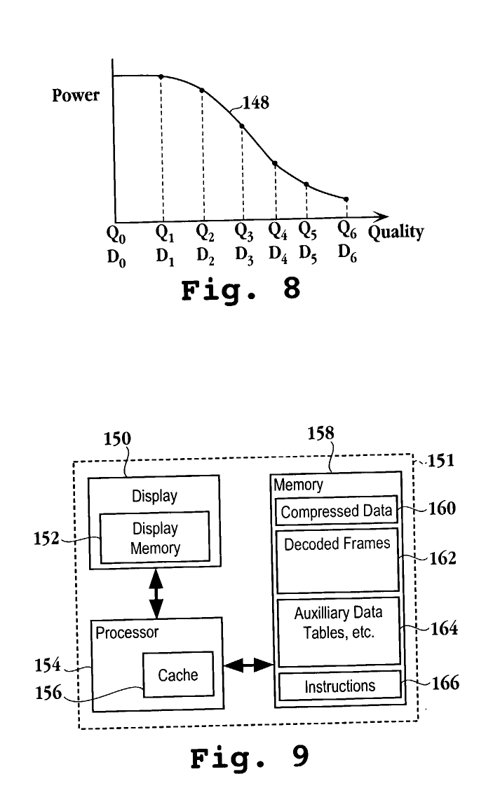

FIG. 6 is a simplified schematic representing the extended error detection feature in accordance with one embodiment of the invention. Here, an error is found during parsing in block 134 of frame 130. However, the actual error began in block 132. Thus, the extended error detection when in the “on” alternative will look at the decoded parts and the corresponding values of the coefficients to correct the error. In contrast, the error concealment module described above will attempt to fill in the hole caused by the error located in block 134, while the extended error detection module will fix the error.

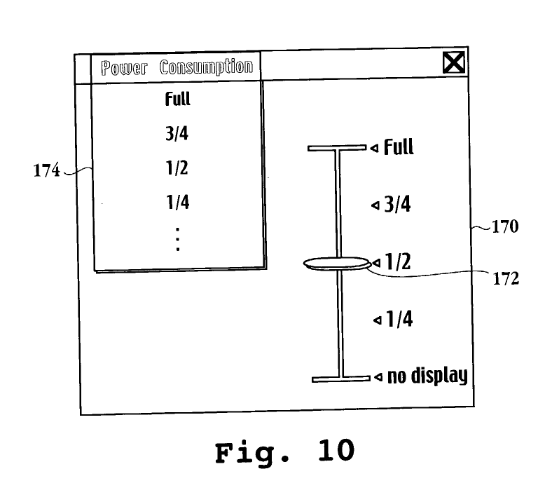

FIG. 7 is a graph of various states defined by different combinations of alternatives from the video decoding modules in accordance with one embodiment of the invention. Here, each of the points on the graph of FIG. 7 define a specific power consumption level and video quality level. For example, point 140-2 may represent a high frame memory compression alternative for the frame memory compression module, a color conversion reduced alternative for the color conversion module, a frame display skipping alternative with k equal to 5 for a frame display skipping module, chroma skipping off for the chroma skipping module, and so on. Alternatively, point 140-1 may represent a high frame memory compression alternative for the frame memory compression module, a color conversion reduced alternative for the color conversion module, a frame display skipping alternative with k equal to 10 for a frame display skipping module, chroma skipping on for the chroma skipping module, and so on. Thus, the difference between the state defined at point 140-1 from the state defined at point 140-2 is that at point 140-1 the frame display skipping module 1 out of very 10 frames are displayed instead of 1 out of every 5 frames, and the chroma skipping on alternative is selected for the chroma skipping module so that the video is displayed in greyscale. Consequently, the power consumption for the video decoding associated with point 140-1 is less than the power consumption associated with point 140-2. Similarly, the video quality for the video decoding associated with point 140-1 is less than the video quality associated with point 140-2.

Still referring to FIG. 7, points 140-1 through 140-6 represent an upper envelope of the points plotted on the graph. In one embodiment, the points of the graph result from a system design phase for a specific target platform. The target platform is a specific choice and configuration of a processor, memory and display that may be incorporated in any of the portable devices described above. In the system design phase, a suitably large set of sample video streams are used to obtain the power consumption and video quality measurements for each video decoding state. For example, with reference to the modules and associated alternatives described above, the total number of video decoding states possible from the combination of the various alternatives is equal to 4×2×4×2×2×3×4×2×2=6144. Thus, for each sample video stream each of the various alternatives can be tested in the design phase to yield a plot of the various points. It should be appreciated that the power consumption may be measured through any suitable method while the video quality may be measured using a suitable subjective evaluation scheme on human subjects. Alternatively, the video quality may be measured using a procedural alternative such as a visual model. Once the points representing the video decoding states are plotted, an upper envelope of the points is identified.

The upper envelope of FIG. 7 is represented by points 140-1 through 140-6. In determining the upper envelope, it should be appreciated that the point providing the highest video quality for a particular power consumption level is chosen. For example, points 142, 144 and 146 are associated with a substantially similar power consumption level as point 140-5. However, point 140-5 has the highest video quality and is selected to be associated with the corresponding power consumption level. In one embodiment, the video decoding states associated with each of the points on the upper envelope are included in the video decoding system for the target platform. It should be appreciated that the design phase may include all the combination of alternatives or some portion thereof. Furthermore, the design phase is not limited to the modules and associated alternatives listed above. That is, any suitable scheme associated with video decoding may be designed to include low, medium, and high alternatives and included in the design phase and then implemented in the video decoding system. One skilled in the art will appreciate that while FIG. 7 illustrates six distinct decoding profiles associated with points 140-1 through 140-6, any suitable number any suitable number of video decoding profiles may be implemented into a device. That is, the power scalable device may incorporate two or more distinct video decoding profiles.

FIG. 8 is an alternative graphical representation of the power versus video quality plot of FIG. 7. Here, decoding states D₀ through D₆ are associated with video quality levels Q₀ through Q₆, respectively. Decoding states D₁ through D₆ are associated with points 140-6 through 140-1, respectively, of FIG. 7. The upper envelope of points on line 148 of FIG. 8, represent the relationship of the degrading video quality level as the power consumption level degrades. For example, the quality level associated with quality level Q₆ on line 148 may only be displaying the video data as greyscale, whereas the video image presented at the decoding state associated with quality level Q₀ on line 148 is displayed in full color. As mentioned with reference to FIG. 7, the number of decoding states is illustrative and not meant to be limiting.

FIG. 9 is a simplified schematic diagram of the components of a video decoding system in accordance with one embodiment of the invention. The components of video decoding system 151 include display 150, processor 154, and memory 158. Display 150 includes display memory 152. Processor 154 includes cache memory 156. Memory 158 is configured to store compressed data 160, decoded frames 162, auxiliary data 164, and instructions 166. It will be apparent to one skilled in the art that display 150 and memory 158 may be connected to processor 154 via a bus, however, for illustrative purposes, the memory and display are shown as being directly connected to the processor. Furthermore, instruction block 166 of memory 158 may not be needed if processor 154 is a special purpose processor, such as a video decoding ASIC. In one embodiment, processor 154 is a liquid crystal display (LCD) controller for controlling display 150. Accordingly, processor 154 decompresses the compressed data to create decoded frames of video and to refresh the display memory appropriately. It should be appreciated that decompression will also involve accessing the decoded frames in memory 158 because of motion compensation. Video decoding system 151 may be incorporated into any of the portable hand-held devices described above. In one embodiment, processor 154 may be configured to monitor a register indicating a power level available to video decoding system 151 so that the video decoding state can be changed as the power available crosses a threshold level.

FIG. 10 represents a schematic diagram of a graphical interface enabling a user to manually select a power consumption level for video decoding in accordance with one embodiment of the invention. Graphical user interface (GUI) 170 includes slider switch 172. Slider switch 172 may be adjusted by a user to select a certain video decoding power consumption level. In addition, graphical user interface 170 may be configured to include any range of power consumption levels, and is not limited to the one-quarter, one-half, three-quarters and full positions shown in the graphical user interface. Alternatively, graphical user interface 170 may include drop-down menu 174 having specific selections for a power consumption level. It will be apparent to one skilled in the art that there are numerous configurations for the graphical interface to allow a user to choose a power consumption level. Accordingly, through GUI 170, a user may choose to run the video decoding system at a low-power consumption level even if the available power is at a high level in order to further conserve power.

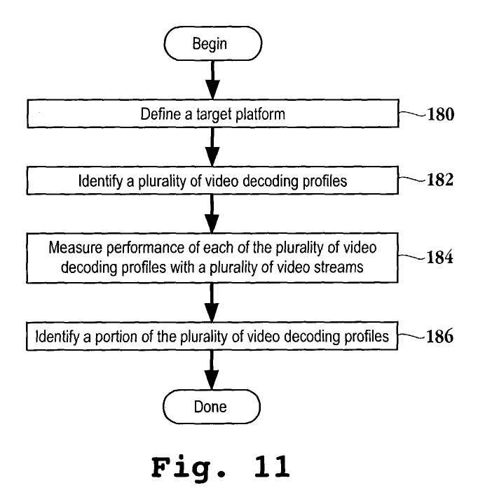

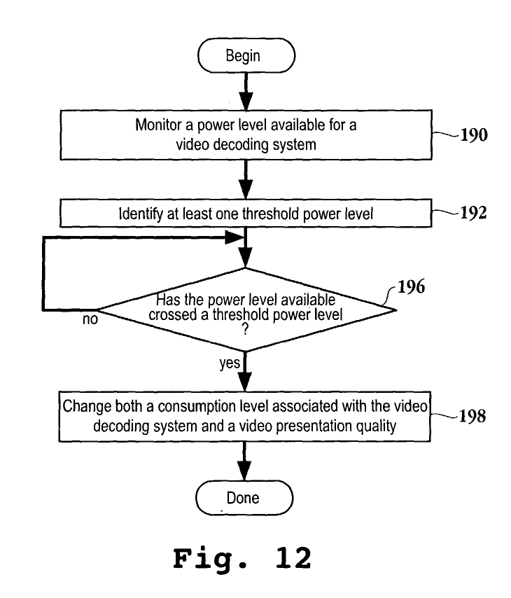

FIG. 11 is a flow chart diagram representing the method operations for determining an optimum pairing of power consumption and video quality for a video decoder in accordance with one embodiment of the invention. It should be appreciated that, the method defined below will describe a design phase scheme where the optimum video decoding profiles are identified. The method initiates with operation 180 where a target platform is defined. The target platform may include a specific processor-type, display type, and memory type for a portable hand-held device such as the devices described above. The method then advances to operation 182 where a plurality of video decoding profiles are identified. Here, the plurality of video decoding profiles may include combinations of alternatives from the modules discussed above. For example, a video decoding profile may combine one of the alternatives from each of the modules described above to define the profile. Alternatively, alternatives from a portion of the modules may also be used. One skilled in the art will appreciate that the embodiments described herein may be used with any video decoding scheme. The method then proceeds to operation 184 where the performance of each of the plurality of video decoding profiles is measured with a plurality of video streams. Here, power level consumption in the video quality level for each of the video decoding profiles is measured and may be plotted on a graph similar to the graphs described with respect to FIGS. 7 and 8. The method then moves to operation 186 where a portion of the plurality of video decoding profiles are identified. In one embodiment, the portion of video decoding profiles is the upper envelope described with reference to FIG. 7. Here, each of the video decoding profiles identified is associated with a different power level.

FIG. 12 is a flow chart diagram illustrating the method operations for decoding image data in a power scalable manner in accordance with one embodiment of the invention. It should be appreciated that the method operations described with reference to FIG. 12 are related to an implementation aspect of the design phase described with reference to FIG. 11. The method initiates with operation 190 where a power level available for a video decoding system is monitored. In one embodiment, a register having data associated with the available power level is monitored to provide the necessary information. The method then advances to operation 192 where at least one threshold power level is identified. The threshold power level defines a power level which triggers a switch to a different video decoding profile when the threshold power level is crossed by the available power level in accordance with one embodiment of the invention.

The method of FIG. 12 then moves to decision operation 196 where it is determined if the power level available to the video decoding system has crossed a threshold power level. Here, the power level available to the video decoding system may be decreasing over time and thus the reduced power level may trigger a switch to a different video decoding profile as the threshold power level is crossed. Alternatively, if the hand-held device is being charged as it is being used, then the power level may be increasing over time and also cross a threshold power level. If the power level available to the video decoding system has not crossed a threshold power level, then the method continues to re-check the power level available at periodic times, or continuously, until the threshold power level has been crossed. If the power level available to the video decoding system has crossed the threshold power level, then the method proceeds to operation 198 where both a power consumption level and a video presentation quality are changed. Here, the video decoding profile is switched. Thus, if the power level available is decreasing, then the video decoding profile is switched to a video decoding profile which consumes less power. On the other hand, if the power level available is increasing, the video decoding profile will switch to a higher power consuming video decoding profile.

In summary, the above described invention describes a device and method for providing a power scalable video decoder. A design phase identifies optimal decoding profiles. For example, the decoding profiles defined on an upper envelope as described above may be used as optimal decoding profiles. The decoding profiles include power consumption alternatives associated with video decoding modules as discussed above. Once the optimal decoding profiles have been identified, then the decoding profiles are implemented into a video decoder. In one embodiment a user is enabled to select a power consumption level through a graphical user interface. Here, the power consumption level is associated with a particular video decoding profile. The power scalable video decoder is configured to monitor a power level available to the video decoder. Accordingly, once the available power level crosses a predefined power level, the video decoder will switch to a different decoding profile. In one embodiment, as the power decreases, the video decoder essentially walks down the upper envelope of decoding profiles illustrated by FIG. 7. Of course, if the power is increasing, the video decoder will walk up the envelope. Therefore, the battery life of the device incorporating the video decoder is extended due to the power scalable video decoding states.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above described invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a communications network.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for determining an optimum pairing of power consumption and video quality for a video decoder, comprising:
defining a target platform;
identifying a plurality of video decoding profiles;
measuring performance of each of the plurality of video decoding profiles with a plurality of video streams; and
identifying a portion of the plurality of video decoding profiles wherein each of the portion of the plurality of video decoding profiles is associated with a different power level.

2. The method of FIG. 1, further comprising:
implementing the portion of the plurality of video decoding profiles into a video decoder.

3. The method of claim 1, wherein the plurality of video decoding profiles include alternatives associated with modules, the modules selected from the group consisting of frame memory compression, color conversion, frame display skipping, frame scaling, chroma skipping, inverse discrete cosine transform, deblocking and deringing, error concealment and extended error detection.

4. The method of claim 1, wherein the target platform is defined by a processor, a display and a memory associated with the video decoder.

5. The method of claim 3, wherein the alternatives are power related alternatives for providing differing display quality levels through functionality associated with each of the modules.

6. The method of claim 1, wherein the method operation of measuring performance of each of the plurality of video decoding profiles with a plurality of video streams includes,
defining points on an upper envelope of a plot of video quality versus power consumption, each of the points corresponding to a single performance measurement of one of the plurality of video decoding profiles applied to one of the plurality of video streams.

7. The method of claim 1, wherein the method operation of measuring performance of each of the plurality of video decoding profiles with a plurality of video streams includes,
quantifying power consumed for decoding each of the plurality of video streams according to each of the plurality of video decoding profiles; and
identifying video quality for decoding each of the plurality of video streams according to each of the plurality of video decoding profiles.

8. A method for decoding image data in a power scalable manner, comprising:
monitoring a power level available for a video decoding system;
identifying threshold power levels; and
in response to the power level available crossing one of the threshold power levels, the method includes,
changing both a power consumption level associated with the video decoding system and a video presentation quality.

9. The method of claim 8, wherein the method operation of monitoring a power level available for a video decoding system includes,
accessing a register having data associated with the power level.

10. The method of claim 8, wherein the threshold power levels are predefined.

11. The method of claim 8, wherein the method operation of changing both a power consumption level associated with the video decoding system and a video presentation quality includes,
determining whether the power level available is decreasing or increasing.

12. The method of claim 11, wherein if the power level available is decreasing, the method includes,
reducing both the power consumption level and the video presentation quality.

13. The method of claim 8, wherein the method operation of changing both a power consumption level associated with the video decoding system and a video presentation quality includes,
adjusting one of an instruction count and a memory access count associated with the video decoding system.

14. A computer program product having program instructions for decoding image data in a power scalable manner, comprising:
program instructions for identifying threshold power levels;
program instructions for monitoring a power level available for a video decoding system;
program instructions for determining when the power level available for the decoding system crosses one of the threshold power levels; and
program instructions for changing both a power consumption level associated with the video decoding system and a video presentation quality, wherein the program instructions for changing are triggered by the power level available crossing one of the threshold power levels.

15. The computer program product of claim 14, wherein the program instructions for monitoring a power level available for a video decoding system, include
program instructions for accessing a register having data associated with the power level.

16. The computer program product of claim 14, wherein the method operation of changing both a power consumption level associated with the video decoding system and a video presentation quality includes,
program instructions for determining whether the power level available is decreasing or increasing.

17. The computer program product of claim 16, wherein if the power level available is decreasing, the method includes,
program instructions for selecting a video decoding profile configured to reduce both the power consumption level and the video presentation quality.

18. A power scalable video decoding device, comprising:
a processor configured to monitor an available power level for the video decoding system in order to select a decoding state for decoding image data, wherein the processor is enabled to adjust the decoding state based upon changes detected to the available power level;
a memory configured to store compressed data and decoded frames associated with the compressed image data;
a display screen configured to present the decoded frames; and
a bus enabling communication between the processor, the memory and the display screen.

19. The power scalable video decoding device of claim 18, wherein the device is selected form the group consisting of a cellular phone, a personal digital assistant, a pocket personal computer, a web tablet and a laptop computer.

20. The power scalable video decoding device of claim 18, wherein the processor is a liquid crystal display (LCD) controller and the display screen is an LCD display screen.

21. The power scalable video decoding device of claim 18, wherein the decoding state includes a combination of alternatives, each one of the alternatives being associated with one of a plurality of modules.

22. The power scalable video decoding device of claim 21, wherein the plurality of modules are selected from the group consisting of frame memory compression, color conversion, frame display skipping, frame scaling, chroma skipping, inverse discrete cosine transform, deblocking and deringing, error concealment and extended error detection.

23. The power scalable video decoding device of claim 21, wherein each one of the alternatives is associated with a different power consumption level.

24. The power scalable video decoding device of claim 18, wherein the processor is one of a digital signal processor (DSP) and an application specific integrated circuit.

25. An integrated circuit chip associated with a video decoding system, comprising:
circuitry for monitoring a power level available to the video decoding system;
circuitry for selecting a video decoding state associated with a first quality level, the video decoding state based upon the power level available;
circuitry for determining when the power level available changes and crosses a threshold power level, thereby causing the circuitry for selecting the video decoding state to select a modified video decoding state associated with a second quality level; and
circuitry for decoding image data according to a selected video decoding state.

26. The integrated circuit chip of claim 25, wherein the video decoding state includes a combination of power consumption alternatives, each one of the power consumption alternatives associated with one video decoding module.

27. The integrated circuit chip of claim 25, wherein the video decoding state and the modified video decoding state differ by at least one power consumption alternative, the at least one power consumption alternative modifying one of an instruction count and a memory access count associated with decoding the image data in order to adjust a power consumption level.

28. The integrated circuit chip of claim 25, wherein as the power level available decreases and crosses a threshold power level, a displayed image associated with the second quality level is of a lower presentation quality than a displayed image associated with the first quality level.

29. A graphical user interface (GUI) rendered by a computing device, comprising:
a user interface for selecting a power consumption mode associated with a video decoder, the user interface including computer code for triggering the selection of the power mode, wherein the user interface allows a user to choose between a plurality of decoding states.

30. The GUI of claim 29, wherein the power consumption mode is selected from a range of power consumption modes provided by a drop down menu.

31. The GUI of claim 29, wherein each power consumption mode from the range of power consumption modes is associated with one of the plurality of decoding states.

32. A method for storing image data for video decoding, comprising:
receiving compressed image data;
decoding the compressed image data into decompressed image data;
identifying luminance and chrominance data corresponding to a frame of image data; and
storing the luminance and chrominance data for the frame of image data contiguously.

33. The method of claim 32, further comprising:
re-compressing the identified luminance and chrominance data for the frame of image data.

34. The method of claim 33, wherein the method operation of re-compressing the identified luminance and chrominance data for the frame of image data includes,
utilizing a differential pulse code modulation compression technique for re-compressing the identified luminance and chrominance data.

35. The method of claim 33, wherein a lossless compression technique is used to re-compress the identified luminance and chrominance data.
